(19) United States
(12) Patent Application Publication
(10) Pub. No.: US 2010/0025338 A1
(43) Pub. Date: Feb. 4, 2010

(54) CHEMICAL ADDITIVE APPARATUS AND METHODS

(75) Inventors: MATTHEW S. HAYAS, CINCINNATI, OH (US); MATTHEW D. HORINE, CINCINNATI, OH (US)

Correspondence Address: WOOD, HERRON & EVANS, LLP, 2700 CAREW TOWER, 441 VINE STREET, CINCINNATI, OH, 45202, US

(73) Assignee: DELAWARE CAPITAL FORMATION, INC., WILMINGTON, DE (US)

(21) Appl. No.: 12/184,339

(22) Filed: Aug. 1, 2008

(51) Int. Cl. C02F 1/68

(52) U.S. Cl. 210/749; 210/206

(57) ABSTRACT

Chemical additive preferably derived from a solid chemical concentrate is selectively educted into the closed water recirculation or makeup line of a water system. A bypass line in one embodiment is controlled by a valve to direct system water through the eductor when chemical additive is desired, and at least a portion thereof around the eductor when no chemical additive is desired. Open line application is disclosed.

This invention relates to liquid treatment and more particularly, to apparatus and methods for treating system liquids with chemical additives. Even more particularly, the invention has special application to the treatment of a variety of water systems with chemical additives.

In the past, it is known to pump chemical additives into water system. As an example, cooling towers typically include a closed water circulation line running through a water or cooling tower and a heat exchangers such as for air conditioning. Other water systems may include boil, waste water, closed water, potable water, swimming pool, hot tub and other system. In such systems, a closed water line circulates through components of the system.

Water and particularly untreated water typically carries with it certain chemical content which can corrode the water lines, or cause unwanted buildup, thus causing flow restrictions, leaks, breakdowns, stoppages, over pressures or the like. In addition, use of untreated water in certain systems may lead to undesirable health-related consequences or issues. To prevent these undesirable consequences, it has been known to pump chemical additives into these closed water lines to treat the water and prevent the expected corrosion, buildup or health-related issues.

In more sophisticated known systems, the water is analyzed, such as by conductivity sensing, to provide a signal responsive to its condition, content or status. Such signals are processed to control one or more pumps, such as diaphragm pumps, to pump desired chemicals into the water at a rate responsive to the sensed condition of the water system.

Presently, a water system manager has two forms of chemical sources for use with such a system. Typically, the chemical additives are provided in either liquid form, which is the major portion of the market, or in solid form. While the solid form has numerous operational advantages, it presents inherent considerations which have limited its use and expansion in the marketplace. In the case of the solid form, a dissolver is typically used to reduce the solid chemical to a liquid form for pumping into a water system through the diaphragm pumps noted above. It is the nature of that liquid mixture which has previously limited the wider use of the solid form of additive.

A difference in the solid and liquid supply formats is that of active chemical concentration. In the liquid format, such concentration is about ten to about twenty percent. In the liquid mixture, reconstituted from a solid concentrate form of chemical, the concentration may be about one-half to about one percent. Accordingly, the liquid additive source contains an active chemical about ten to about forty times the active content of the liquid mixture obtained from the solid chemical supply form. At the pumped rate of about one gallon of liquid per hour into the system, the active concentration of chemical from the solid form supply may not be of sufficient concentration to be effective for the desired purpose.

Accordingly, whatever the base form or source of additive or liquid, both either are liquid or are reduced to liquid, then pumped into the water system at desired rates and concentrations.

Both are typically pumped into the water system with which they are used. These pumps may be of a variety of configurations. Such pumps may be peristaltic or diaphragm pumps or other forms of typically heavy construction and of significant expense in relation to the system. Such pumps must be maintained and usually have a finite life or cycle time, at the end of which they must be replaced.

In one typical diaphragm pump system, for example, the diaphragm pumps are generally capable of pumping about one gallon per hour into the water system. Thus, the total liquid treating mixture from a liquid source which can be added to the system over 24 hours is about 24 gallons. Where a solid additive source is used, at the same one gallon per hour rate, the total active chemicals which can be added to the system is thus significantly less than the amount of additives presented to the system where a liquid additive source, at its higher active concentration, is used. This inherent circumstance has created a market wherein the powder or solid source products, at their lower active component concentration, are at a significant competitive disadvantage, despite their other advantages which are numerous.

The advantages of using a solid state additive source, however, apart from their available concentration levels are significant. These include the ease of using a solid as compared to a liquid. Fewer spills are experienced with the solids sources and these, if any, are much more readily cleaned up. Safety is improved as liquids are more difficult to handle and if leaked or spilled from their containers when stored or when unloaded into the pumps. Contact with the solid source is more easily avoided, and more easily resolved if skin contact is made.

Moreover, the pumps used in both solid or liquid source systems have finite lives, require maintenance or replacement and are expensive. And when the water systems to be treated are very large, much larger and more expensive additive pumps are required.

Accordingly, it is desirable to facilitate the use of solid chemical additives in water treatment systems.

It is also desirable to provide improved water treatment systems for adding chemical additives to a water system.

It is further desirable to provide a water treatment system using a solid chemical additive source but capable of providing active chemical compounds at an even higher concentration, over time, rather than prior pump systems using liquid chemical additive sources.

It is also desirable to provide an improved chemical additive apparatus and methods for a water system when pumps of traditional configuration are eliminated.

To these ends, an improved water treatment apparatus according to one embodiment of the invention includes an eductor spliced into a pressurized water system line preferably on the pump outlet side of a closed water system. A valve upstream of the eductor has one position where water in the system is directed through the eductor. In another position, the valve directs system water flow around the eductor and into the closed water system downstream of the eductor.

The eductor is connected to a source of chemical additives preferably produced by a dissolver acting to dissolve a solid chemical additive source to a liquid mixture state. This liquid is drawn up into, and mixed with, the system water to be treated at a rate which significantly exceeds that of liquids pumped into the system by the prior additive devices. In particular, the eductor as used in the preferred embodiment noted above is capable of supplying not one gallon per our as with a pump, but up to about sixty gallons of liquid chemical additive per hour into the system. At such a rate, the active chemical added to the system can far exceed the effective concentration added by the prior pumped system even where a liquid additive source, itself having a higher chemical concentration, is used. For example, even at the low one half percent active component concentration for a solid additive source, a significant amount of chemical additive can be added per hour (at sixty gallons per hour), well beyond the prior pumped systems where only about one gallon per hour was attained.

While these new apparatus and methods could, of course, be used to add chemical from a liquid source, the invention will find significant use in enabling water system owners and managers to threat their systems from a solids additive source, with sufficient additives for system maintenance and corrosion preventance while attaining the advantages of a solids additive source. No longer is it necessary to use a liquid source to attain a desired level of chemical additive concentration. In fact, even higher concentrations can be attained over time as compared with liquid additive pumped systems.

Moreover, such new apparatus and methods can be used in large pressurized water systems, without the need of expensive large additive pumps or the energy to drive them.

These and other advantages will be readily ascertained from the following written description of a preferred embodiment and from the drawings in which:

### BRIEF DESCRIPTION OF THE DRAWINGS

FIG. 1 is a diagrammatic illustration of a water system modified by the addition of a water treatment apparatus according to the invention;

FIG. 2 is an enlarged perspective view of the eductor and bypass apparatus of FIG. 1;

FIG. 3 is a perspective view of a dissolver board system as in FIG. 1;

FIG. 4 is a schematic diagram illustrating operation of the invention where chemical is being added to a water system; and

FIG. 5 is a schematic view similar to FIG. 4 but illustrating operation of the invention where system water is bypassed around the eductor with no chemical being added to the water system.

### DETAILED DESCRIPTION OF A PREFERRED EMBODIMENT

Turning now to the Figures, it will be appreciated that the invention is directed to apparatus for introducing chemical additive to a water line system such as a water tower, cooling tower, boiler, waste water, potable water swimming pool, hot tub or other water line system where chemical may be added to water flowing under pressure in a closed water line. This is opposed to an open-line system where eductors are used to add chemical to a water flowing in an essentially open line system, such as in a chemical proportioner and dispenser for producing a mixture for cleaning, sanitation, foaming, for example, and wherein the only water pressures are incidental to the inherent pressures of water being released to atmosphere through an eductor.

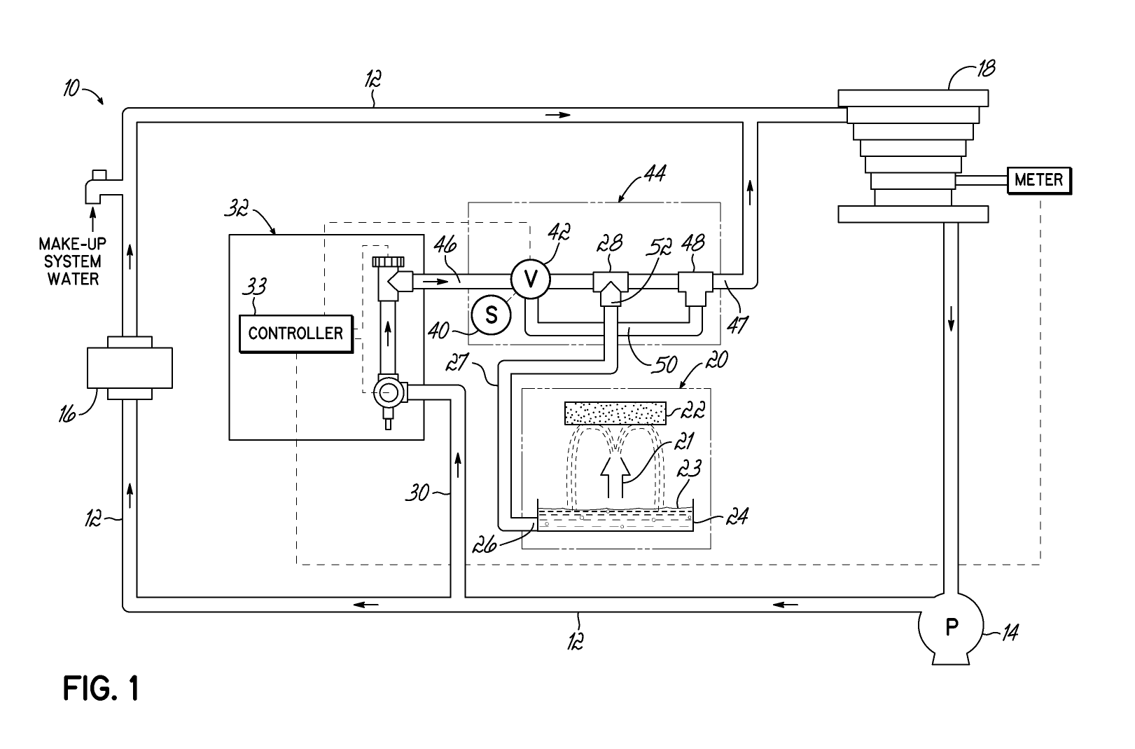

FIG. 1 illustrates a water system 10 having a closed water line 12 circulating water from pump 14 through a heal exchange and cooling tower 18.

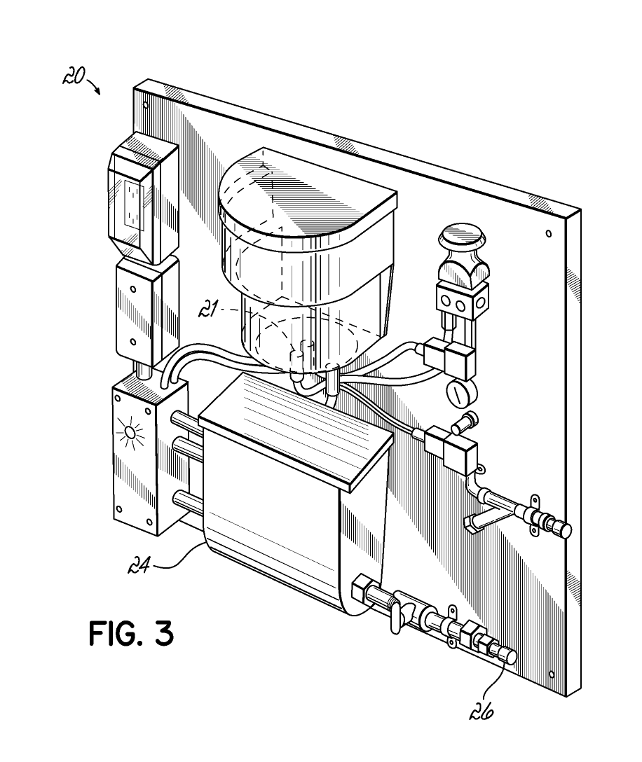

A dissolver board 20 is provide with a nozzle 21 for spraying water onto a solid chemical concentrate supply in the form of a block 22 to generate a liquid mixture 23 of water and chemical collected in a reservoir 24. A liquid outlet 26 from reservoir 24 is operably connected to an eductor 28 through line 27. The dissolver board 20 may be any suitable type and could be as described in U.S. Pat. No. 6,820,661 or in United States Publication No. 2007/0269894A1, published on Nov. 22, 2007 and entitled “Solution Dispensing System”. Both documents are expressly incorporated herein by reference as if fully and expressly described in their entirety herein. Any suitable apparatus for converting or reducing the solid chemical supply 22 to a liquid mixture 23 can be used. For example, the dissolver board 20 depicted in FIG. 3 is like that described in FIG. 1 of U.S. Pat. No. 6,820,661 and reference is made therefor for clarity. In addition, the additive diluted from a solid mix can be supplied from any source such as a dilution bowl, drum, pail, tote or other source than a reservoir from a dissolver system. The word “reservoir” is thus herein used broadly without limitation to a particular container and a dissolver board. The chemical so supplied may also come from any form such as a solid or from a liquid form, if desired, and whether in prepared form or mixed onsite.

FIG. 1 further illustrates a water line 30 connected to line 12 for diverting water and line pressure to a water analysis apparatus 32 including a controller 33. Water flowing through apparatus 32 is sensed or analyzed to indicate a condition of the water with respect to its chemical content. The analysis in response to the sensed condition of the system water generates a controller signal which is transmitted to a solenoid 40 connected to operate valve 42 as will be described.

It will be appreciated that any suitable form of water analysis apparatus 32 and controller could be used, such as those shown in U.S. Pat. No. 6,418,958, expressly incorporated herein by reference, in aforesaid United States Patent Publication No. US2007/0269894A1, also incorporated herein by reference, or any other suitable form of water analysis or condition detecting apparatus.

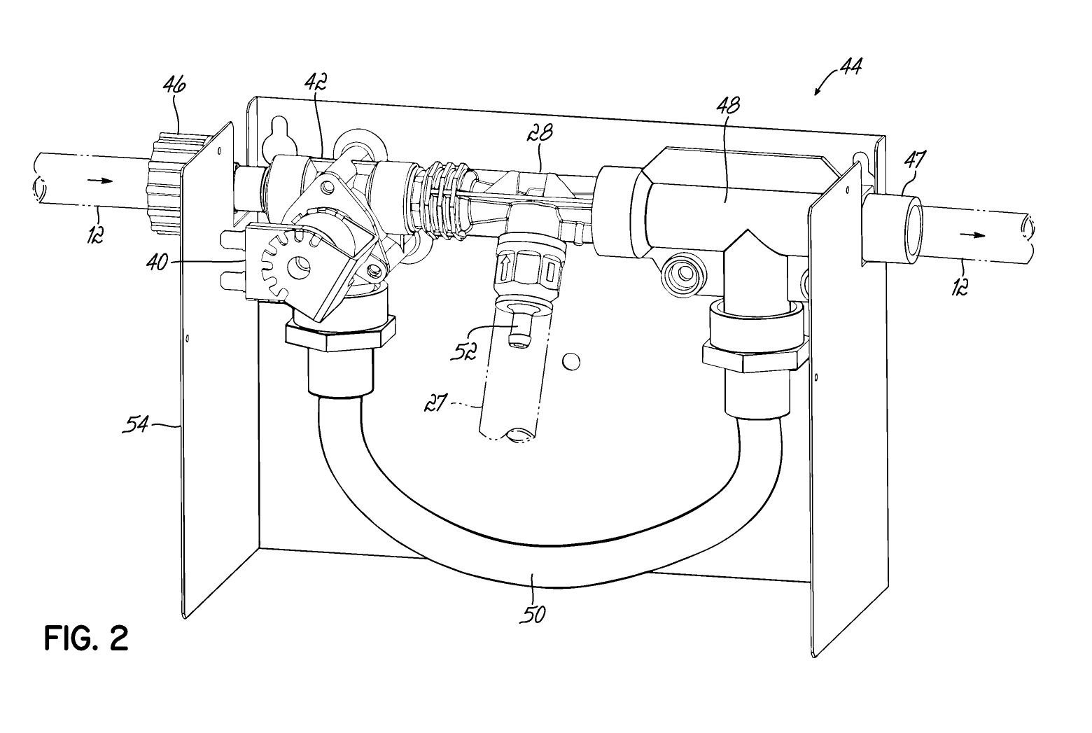

Turning now to FIG. 2, there is illustrated therein the apparatus which is operable to either draw chemical additive into system water flowing therethough or to bypass the eductor when no additive is required.

An additive apparatus 44, according to one embodiment of the invention as shown in FIG. 2, includes an input 46 for connection to water line 30 from water analysis apparatus 32, a water line output port 47, a valve operating solenoid 40, a valve 42, an eductor 28, a bypass connector 48, a bypass line 50 and an eductor input port 52 for connection to a chemical additive through line 27, in the preferable form of a liquid mixture 23 reduced from a solid chemical concentrate form 22. These components may be mounted on or supported by a bracket apparatus 54 or other mounting apparatus as desired for supporting them in conjunction with a water system 10.

Valve 42 is of any suitable type valve having at least an input operably connected to receive water from line 12 and input 46 and two outlets. One outlet is operably connected to eductor 28 and the other outlet to bypass line 50.

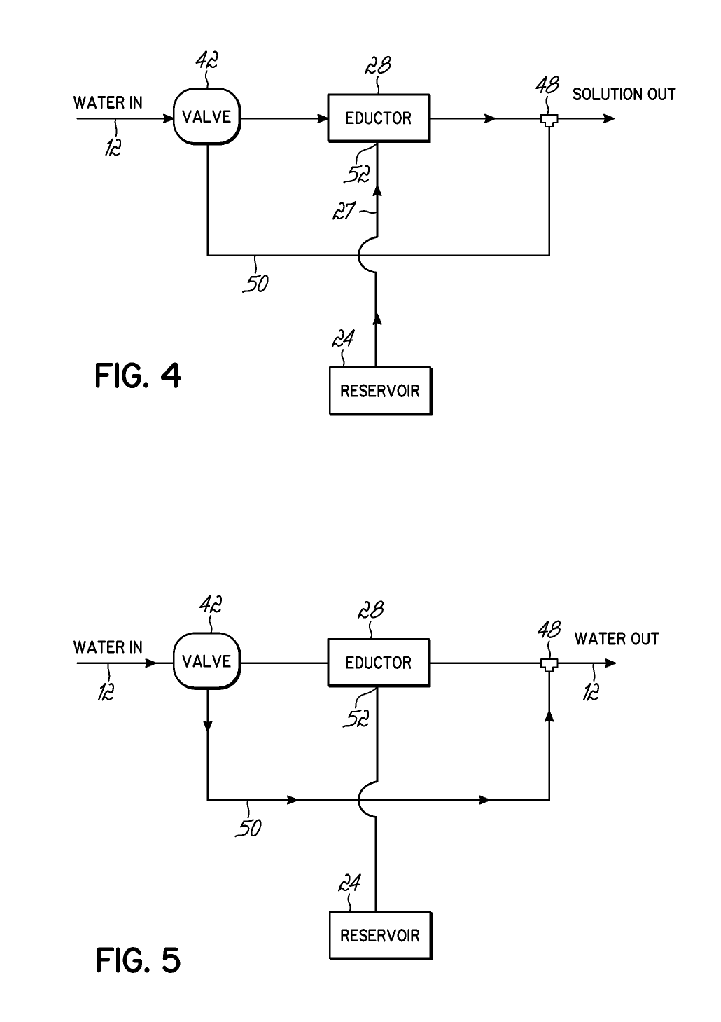

In FIGS. 4 and 5, the operative flow of system water is shown by the allows in those respective figures. In one condition, solenoid 40 moves valve 42 to direct water from line 12 to bypass line 50, around eductor 28 and to line 12, all without passing water through eductor 28 (FIG. 5). In another condition, solenoid 40 moves valve 42 to a position where water is directed to eductor 28. Bypass line 50 is closed (FIG. 4). In this condition, water flowing through eductor 28 creates suction in the eductor, operable to draw liquid chemical additive mixture through poll 52. Additive is drawn into system water flowing through and from eductor 28, through connector 48 and into closed water line 12.

It will be appreciated that in typical water systems having closed water lines 12, pressures are typically within the range of about 40 psi to about 80 psi. For these ranges, an eductor 28 is selected which is capable of adding from about one gallon per hour to about sixty gallons per hour of liquid chemical additive mid preferably about one to about ten gallons per hour. Various known eductors, metering orifices and other eductor parameters or accessories can be used to produce the desired chemical flow for any given system when additive is desired.

It will of course, be appreciated that solenoid 40 is preferably operated in response to a signal generated by the sensed condition of system water. Alternatively, a controller operating solenoid 40 might be programmed to automatically operate solenoid 40 and valve 42 in a predetermined fashion such as in predetermined time intervals or periods, or in response to a signal initiated by a timer. Also, the solenoid 40 and valve 42 could be operated in response to a signal derived from a water meter (including a reading therefrom). In a yet further alternative, the solenoid may be replaced with a servo-type valve operator to control a proportional operation of a valve 42 configured to pass some system water through eductor 28 and some system water simultaneously through bypass line. This could be used to facilitate control of the ratio of liquid chemical additive to system water as may be desired.

It will be further appreciated that dilution rates could be varied from about 3:1 to about 4,000:1 and could be greater than 1 mm:1.

In an alternate embodiment, the apparatus 44 could be operatively connected into a makeup water line instead of a recirculation line as shown in the FIGS. In such an alternative, the solenoid 40 may be eliminated and all incoming water treated without need of a bypass line.

In yet other alternate embodiments, the solenoid may be any of normally closed, normally open or three way solenoids. A manually or pneumatically operated valve could be used in place of an electrically operated valve 42. Moreover, as noted above, signals from a timer, controller or water meter could be used to operate valve 42.

In yet a further aspect of the invention it will be appreciated that valve 42 could be controlled by any suitable expedient in one position to only partially throttle the eductor 28, such that when no additive is desired, water flow is shut off sufficiently lo prevent creation of suction and resulting induction of chemical through the eductor, but some water flow through the eductor, insufficient to draw up chemical additive, is continued.

In yet a further aspect of the invention, it will be appreciated that when no additive is desired, the feed line from the chemical source could be blocked, such as by a valve, while water flow through eductor 28 was continued.

Accordingly, the invention is useful to provide chemical additive from a solid chemical concentrate to a water system at a rate sufficient to have the desired additive effect and without the use of mechanical pumps. Benefits of using a solid additive supply are attained without undue concern over the rate of active additive input.

While the preferred embodiment and use of the invention, which contemplates the unique combination of an eductor and a selective eductor bypass, has been described in connection with a closed or pressurized water system, the invention in another aspect might be used for water or other diluent treatment systems of an open line configuration where the eductor effluent and the selective bypass effluent are discharged into a non-pressurized environment such as an open tank or other open facility. Accordingly, the invention could be used in similar ways as that described above for an even wider variety of treatment systems and with the use of dilutions from either solid or liquid concentrated chemical sources.

These and other modifications will become readily apparent from the foregoing to one of ordinary skill in the art without departing from the scope of the invention and applicant intends to be bound only by the claims appended hereto.

What is claimed is:

1. Apparatus for a water system, and including
an eductor operably connected in a closed water line, said eductor being operably and selectively connected to a chemical supply for drawing chemical into said closed water line when water runs through said eductor.

2. Apparatus as in claim 1 further including a solid chemical dissolver including a solid chemical receiver, a nozzle for directing water onto said solid to mix water and chemical, a reservoir for containing a mixture of chemical and water and a mixture outlet from said reservoir, wherein
said eductor includes a chemical pick-up port operably connected to the mixture outlet of said reservoir for drawing mixture into said water line.

3. Apparatus as in claim 2 wherein said mixture contains about one half to about one percent of active chemical compound.

4. Apparatus as in claim 1 further including a water bypass line connected at respective ends thereof to said water line at respective positions upstream and downstream of said eductor.

5. Apparatus as in claim 4 further including a valve upstream of said eductor in one position directing water in said line through said eductor and in another position directing water in said line into said water bypass line and around said eductor.

6. Apparatus as in claim 5 wherein said valve in another position passes a predetermined flow of water, through said eductor insufficient to draw chemical into said line, and passes excess water into said line downstream of said eductor.

7. Apparatus as in claim 4 including a valve controller, said controller operable to move said valve between said positions in response to a sensed condition of water in said water line.

8. Apparatus as in claim 4 including a valve controller, said controller operable to move said valve between said positions in response to one of a signal from a timer or a signal derived from a water meter.

9. Apparatus for treating water systems having a closed water line for conducting water through said system, said apparatus comprising:
an eductor operably connected in said water line and having an inlet port connected to a chemical supply,
a bypass water line operably disposed around said eductor to carry water in said system around said eductor;
a valve for selectively directing water to said eductor for mixing chemical in said water line, or around said eductor for preventing the introduction of chemical through said eductors and into said water lines.

10. Apparatus as in claim 9 wherein said valve includes two water outlets, one connected to said eductor and one connecting to said bypass water line.

11. Apparatus as in claim 10 wherein a downstream end of said bypass line is connected to said water line downstream of said eductor.

12. A water system including a closed water line for conducting water throughout the system and including chemical adding apparatus operably coupled in said line for adding water-treating chemical to treat water in said line, and further including:
an eductor operably connected in said water line and having in upstream water inlet connected to said line and a downstream water outlet connected to said line,
said eductor having a chemical inlet suction port operably connected to a chemical supply for drawing chemical into water flowing through said eductor,
an eductor bypass conduit connected to said water line upstream and downstream of said eductor for bypassing water flow around said eductor, and
a valve for directing water flow in said water line selectively through or around said eductor.

13. Apparatus as in claim 12 including:
a chemical supply comprising a solid chemical dissolver for producing a liquid chemical mixture from a solid chemical, said supply including a mixture outlet operably connected to the chemical inlet suction port of said eductor.

14. A method of introducing chemical additive into a closed water line in a water system and including:
flowing water in said line through an eductor operably coupled in said line and drawing chemical into said water line in response to water flow through said eductor.

15. A method as in claim 14 including the preliminary step of directing water onto a solid chemical and dissolving said solid to produce a chemical mix, then drawing said mix through said eductor and into said water line.

16. A method as in claim 15 including the step of flowing water in said line around said eductor when chemical is not to be added to said water in said water line.

17. A method as in claim 14 including educting chemical into said water line at a rate up to about sixty gallons per hour.

18. Apparatus for treating a diluent and including:
an eductor operably connected to a source of diluent;
said eductor being operably and selectively connected to a chemical supply for drawing chemical into said diluent when diluent flow through said eductor; and
an eductor bypass line for selectively diverting diluent around said eductor.
